(19) United States
(12) Patent Application Publication
(10) Pub. No.: US 2026/0025426 A1
(43) Pub. Date: Jan. 22, 2026

(54) CLUSTER LOAD BALANCING METHOD AND APPARATUS

(71) Applicant: Tencent Technology (Shenzhen) Company Limited, Shenzhen (CN)

(72) Inventors: Junhong YE, Shenzhen (CN); Faqiang WANG, Shenzhen (CN); Xianping ZHOU, Shenzhen (CN); Feng JIN, Shenzhen (CN)

(73) Assignee: Tencent Technology (Shenzhen) Company Limited, Shenzhen (CN)

(21) Appl. No.: 19/337,198

(22) Filed: Sep. 23, 2025

Related U.S. Application Data
(63) Continuation of application No. PCT/CN2024/110351, filed on Aug. 7, 2024.

(30) Foreign Application Priority Data
Oct. 13, 2023 (CN) 202311331890.X

(51) Int. Cl. H04L 67/1008

(52) U.S. Cl. CPC H04L 67/1008

(57) ABSTRACT

This application discloses a cluster load balancing method and apparatus. The method includes: obtaining, when congestion information reported by a target server in a target cluster is obtained, a congested port and server status information of the target cluster (201); determining an active connection passing through the congested port as a to-be-switched connection (202); determining, as a target switching path, a path of a candidate connection in a candidate connection list corresponding to an active connection list including the to-be-switched connection (203); and delivering the to-be-switched connection and the target switching path to a server corresponding to the to-be-switched connection, to enable the server corresponding to the to-be-switched connection to switch a path of the to-be-switched connection to the target switching path (204).

### RELATED APPLICATION

This application is a continuation application of PCT Patent Application No. PCT/CN2024/110351, filed on Aug. 7, 2024, which claims priority to Chinese Patent Application No. 202311331890.X, filed with the China National Intellectual Property Administration on Oct. 13, 2023, each of which is incorporated herein by reference in its entirety.

### FIELD OF THE TECHNOLOGY

This application relates to the field of load balancing technologies, and specifically, to a cluster load balancing method and apparatus.

### BACKGROUND OF THE DISCLOSURE

An existing load balancing solution includes a flow-level equal-cost-multi-path (ECMP) hash solution. Currently, the flow-level ECMP hash solution is most widely used in data centers. In the ECMP solution, a five-tuple of a data packet is used as input to calculate an egress port of a next-hop route. Because all data packets of a data flow have the same five-tuple, these data packets all reach a receiving end along the same physical network path. From the perspective of load balancing performance, ECMP hash is very random, and a relatively good load balancing effect (based on the law of large numbers of mathematical statistics) can be achieved only when there are a large quantity of data flows (for example, there are thousands of flows in a single switch). However, in an AI training scenario, when a quantity of flows is not large, apparent load imbalance and even hash polarization often occur in ECMP. Consequently, most traffic only takes an extremely small quantity of network paths, and a large quantity of bandwidths is wasted. In addition, because most data flows are congested on a few network paths, throughput of each flow is severely constrained. This ultimately resulted in a severe damage to service throughput, and ultimately causes a low cluster load balancing degree and low bandwidth utilization.

In other words, in the related art, a cluster load balancing degree and bandwidth utilization are low.

### SUMMARY

Embodiments of this disclosure provide a cluster load balancing method and apparatus.

According to a first aspect, this application provides a cluster load balancing method, applied to a centralized controller, and the cluster load balancing method including:
obtaining, when congestion information reported by a target server in a target cluster is obtained, a congested port and server status information of the target cluster, the target cluster including a plurality of servers and a plurality of switches, the switch including a plurality of switch ports, and the server status information including an active connection list between the servers and a corresponding candidate connection list;
determining an active connection passing through the congested port as a to-be-switched connection;
determining, as a target switching path, a path of a candidate connection in a candidate connection list corresponding to an active connection list including the to-be-switched connection; and
delivering the to-be-switched connection and the target switching path to a server corresponding to the to-be-switched connection, to enable the server corresponding to the to-be-switched connection to modify a path of the to-be-switched connection to the target switching path.

According to a second aspect, this application provides a cluster load balancing method, applied to a server in a target cluster, the target cluster including a centralized controller, a plurality of servers, and a plurality of switches, the switch including a plurality of switch ports, and the cluster load balancing method including:
establishing an active connection to the server in the target cluster and transmitting a target data packet;
detecting whether a congested connection (or congestion condition) exists in active connections;
sending congestion information to the centralized controller when the congested connection (or congestion condition) exists in the active connections, the centralized controller being configured to: obtain a congested port and server status information of the target cluster when receiving the congestion information; determine an active connection passing through the congested port as a to-be-switched connection; and determine, as a target switching path, a path of a candidate connection in a candidate connection list corresponding to an active connection list including the to-be-switched connection, and the server status information including an active connection list between the servers and a corresponding candidate connection list; and
obtaining the to-be-switched connection and the target switching path that are delivered by the centralized controller, and modifying a path of the to-be-switched connection to the target switching path.

According to a third aspect, this application provides a cluster load balancing apparatus, used in a centralized controller, and the cluster load balancing apparatus including:
an obtaining module, configured to obtain, when congestion information reported by a target server in a target cluster is obtained, a congested port and server status information of the target cluster, the target cluster including a plurality of servers and a plurality of switches, the switch including a plurality of switch ports, and the server status information including an active connection list between the servers and a corresponding candidate connection list;
a connection determining module, configured to determine an active connection passing through the congested port as a to-be-switched connection;
a path determining module, configured to determine, as a target switching path, a path of a candidate connection in a candidate connection list corresponding to an active connection list including the to-be-switched connection; and
a delivery module, configured to deliver the to-be-switched connection and the target switching path to a server corresponding to the to-be-switched connection, to enable the server corresponding to the to-be-switched connection to modify a path of the to-be-switched connection to the target switching path.

According to a fourth aspect, this application provides a cluster load balancing apparatus, used in a server in a target cluster, the target cluster including a centralized controller, a plurality of servers, and a plurality of switches, the switch including a plurality of switch ports, and the cluster load balancing apparatus including:
a transmission module, configured to establish an active connection to the server in the target cluster and transmit a target data packet;
a detection module, configured to detect whether a congested connection (or congestion condition) exists in active connections;
a sending module, configured to send congestion information to the centralized controller when the congested connection (or congestion condition) exists in the active connections, the centralized controller being configured to: obtain a congested port and server status information of the target cluster when receiving the congestion information; determine an active connection passing through the congested port as a to-be-switched connection; and determine, as a target switching path, a path of a candidate connection in a candidate connection list corresponding to an active connection list including the to-be-switched connection, and the server status information including an active connection list between the servers and a corresponding candidate connection list; and
a modification module, configured to obtain the to-be-switched connection and the target switching path that are delivered by the centralized controller, and modify a path of the to-be-switched connection to the target switching path.

According to a fifth aspect, this application provides an electronic device, including a memory and a processor, the memory having computer-readable instructions stored therein, and the processor being configured to run the computer-readable instructions in the memory, to implement operations in the cluster load balancing method provided in this application.

According to a sixth aspect, this application provides a computer-readable storage medium, having a plurality of instructions stored thereon, and the instructions being loadable by a processor, to implement operations in the cluster load balancing method provided in this application.

According to a seventh aspect, this application provides a computer program product, including a computer program or instructions, the computer program or the instructions, when executed by a processor, implementing operations in the cluster load balancing method provided in this application.

Details of one or more embodiments of this disclosure are provided in the following accompanying drawings and descriptions. Other features, objectives, and advantages of this application become apparent from the specification, the accompanying drawings, and the claims.

### BRIEF DESCRIPTION OF THE DRAWINGS

To describe the technical solutions of embodiments of this disclosure more clearly, the following briefly introduces the accompanying drawings required for describing embodiments. Apparently, the accompanying drawings in the following descriptions show merely a part of embodiments of this disclosure, and a person skilled in the art may still derive other drawings from these accompanying drawings without creative efforts.

FIG. 1 is a schematic diagram of a scenario of a cluster load balancing system according to an embodiment of this disclosure.

FIG. 2 is a topology view of a target cluster in a cluster load balancing system according to an embodiment of this disclosure.

FIG. 3 is a schematic diagram of topology paths of a server group in a cluster load balancing system according to an embodiment of this disclosure.

FIG. 4 is a schematic diagram of an expanded single Pod topology in a cluster load balancing system according to an embodiment of this disclosure.

FIG. 5 is a schematic diagram of ECMP hash in the related art.

FIG. 6 is a schematic flowchart of an embodiment of a cluster load balancing method according to an embodiment of this disclosure.

FIG. 7 is a schematic flowchart of another embodiment of a cluster load balancing method according to an embodiment of this disclosure.

FIG. 8 is a schematic diagram of routing hash configuration of switches in a cluster load balancing method according to an embodiment of this disclosure.

FIG. 9 is a schematic diagram of source port number grouping in a cluster load balancing method according to an embodiment of this disclosure.

FIG. 10 is a schematic diagram of source port number grouping at an aggregation layer in a cluster load balancing method according to an embodiment of this disclosure.

FIG. 11 is a schematic diagram of source port number grouping at a core layer in a cluster load balancing method according to an embodiment of this disclosure.

FIG. 12 is a schematic diagram of source port number grouping at an access layer in a cluster load balancing method according to an embodiment of this disclosure.

FIG. 13 is a schematic diagram of server status information maintained by a server in a cluster load balancing method according to an embodiment of this disclosure.

FIG. 14 is a schematic diagram of switch status information, server status information, and a topology view of a target cluster that are maintained by a centralized controller in a cluster load balancing method according to an embodiment of this disclosure.

FIG. 15 is a schematic flowchart of still another embodiment of a cluster load balancing method according to an embodiment of this disclosure.

FIG. 16 is a schematic flowchart of still another embodiment of a cluster load balancing method according to an embodiment of this disclosure.

FIG. 17 is a schematic flowchart of still another embodiment of a cluster load balancing method according to an embodiment of this disclosure.

FIG. 18 is a schematic diagram of a congestion probability of at least one connection in a cluster load balancing method according to an embodiment of this disclosure.

FIG. 19 is a schematic diagram of a congestion probability of a connection in a cluster load balancing method according to an embodiment of this disclosure.

FIG. 20 is a schematic diagram of a structure of an embodiment of a cluster load balancing apparatus according to an embodiment of this disclosure.

FIG. 21 is a schematic diagram of a structure of another embodiment of a cluster load balancing apparatus according to an embodiment of this disclosure.

FIG. 22 is a schematic diagram of a structure of a switch, a centralized controller, and a server according to an embodiment of this disclosure.

FIG. 23 is a schematic diagram of a structure of an electronic device according to an embodiment of this disclosure.

### DESCRIPTION OF EMBODIMENTS

The principle of this application is described by using an example in which this application is implemented in a proper computing environment. The following descriptions are based on illustrated specific embodiments of this disclosure, and are not be construed as a limitation to other specific embodiments of this disclosure that are not described in detail herein.

In the following descriptions of this application, the term “some embodiments” describes subsets of all possible embodiments, but “some embodiments” may be the same subset or different subsets of all the possible embodiments, and can be combined with each other without conflict.

In the following descriptions of this application, the terms “first”, “second”, and “third” are merely intended to distinguish between similar objects rather than describe specific orders. The terms “first”, “second”, and “third” may, where permitted, be interchangeable in a particular order or sequence, so that embodiments of this disclosure described herein may be performed in an order other than that illustrated or described herein.

Unless otherwise specified, all technical and scientific terms used in this specification have same meanings as those usually understood by a person skilled in the art of this application. The terms used in this specification are merely intended to describe objectives of embodiments of this disclosure, and are not intended to limit this application.

To improve efficiency of performance testing of an application program, embodiments of this disclosure provide a cluster load balancing method, a cluster load balancing apparatus, an electronic device, a computer-readable storage medium, and a computer program product. The cluster load balancing method may be performed by the cluster load balancing apparatus, or may be performed by an electronic device integrated with the cluster load balancing apparatus.

The technical solutions in embodiments of this disclosure are clearly and completely described below with reference to the accompanying drawings in embodiments of this disclosure. Apparently, the described embodiments are merely some rather than all of embodiments of this disclosure. All other embodiments obtained by a person skilled in the art based on embodiments of this disclosure without creative efforts shall fall within the protection scope of this application.

With reference to FIG. 1, this application further provides a cluster load balancing system. As shown in FIG. 1, the cluster load balancing system includes a target cluster and a centralized controller 200. The target cluster includes a plurality of servers 100 and a plurality of switches 300. The switch includes a plurality of switch ports. A cluster load balancing apparatus provided in this application is integrated in the centralized controller and the server.

The centralized controller may be any device configured with a processor and has a processing capability, for example, a mobile electronic device having a processor such as a smartphone, a tablet computer, a palmtop computer, a notebook computer, or a smart speaker, or a fixed electronic device having a processor such as a desktop computer, a television, a server, or industrial equipment.

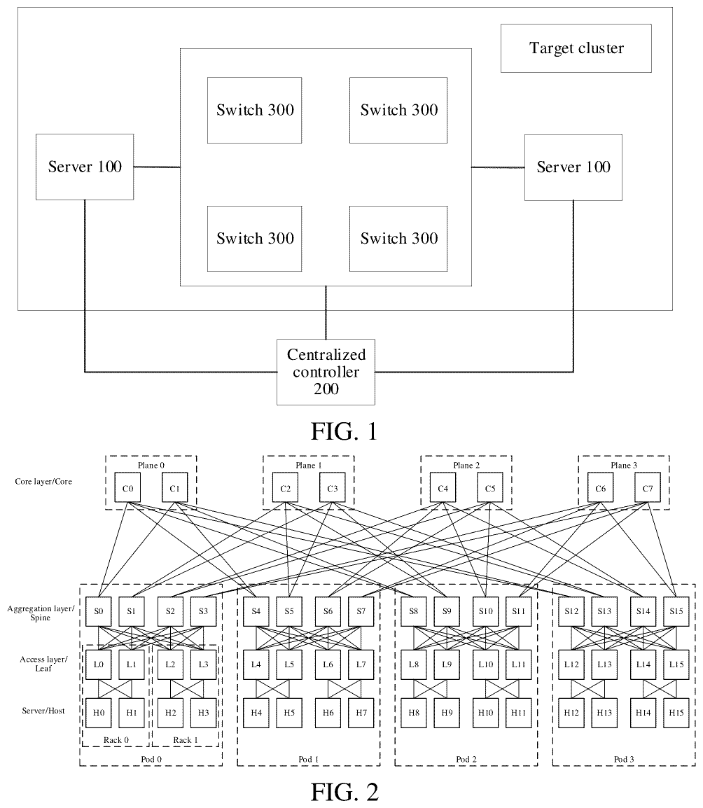

As shown in FIG. 2, in a specific embodiment, the target cluster includes a plurality of switch layers and a plurality of servers. The plurality of switch layers are respectively an access layer Leaf, an aggregation layer Spine, and a core layer Core, and a layer of servers Hosts. A switch at the access layer and a server downstream connected to the access layer are collectively referred to as a rack. A switch at the access layer, all aggregation-layer switches upstream connected to the access layer, and all servers downstream connected to the access layer are collectively referred to as a module (pod). A plurality of core-layer switches form a plane. For example, in FIG. 2, switches L0 and L1 at the access layer and servers H0 and H1 downstream connected to the switches form a rack. All devices in a first dashed box passing the access layer Leaf, the aggregation layer Spine, and the layer of servers Hosts form a network module (Pod). In a mainstream data center network, to increase communication bandwidths and improve connection reliability between servers, a server is usually upstream connected to two access-layer switches through two links, and two network interfaces are respectively connected to the two switches on a network interface card of the server. Aggregation-layer switches having the same Pod sequence number are connected to all core switches in the same core plane. For example, a first aggregation-layer switch S0 of a Pod 0, a first aggregation-layer switch S4 of a Pod 1, and the like are all connected to all switches in a plane 0 at the core layer. A quantity of planes at the core layer is the same as a quantity of aggregation-layer switches of one Pod. In an actual data center, generally, there are eight core planes, and each plane has eight core switches. In addition, a network has more than a dozen Pods, one Pod usually has eight aggregation-layer switches and more than a dozen racks, and one rack has more than a dozen servers. A quantity of aggregation-layer switches of each Pod is denoted as NS, a quantity of switches in each plane at the core layer is denoted as NC, and a quantity of Leaf switches of each rack is denoted as NL.

As shown in FIG. 2, the access layer Leaf includes 16 access-layer switches, which are respectively numbered as H0 to H15. The aggregation layer Spine includes 16 aggregation-layer switches, which are respectively numbered as S0 to S15. The core layer Core includes eight core-layer switches, which are respectively numbered as C0 to C7, and the core layer Core includes four planes, which are respectively numbered as plane 0 to plane 3. The layer of servers Hosts includes 16 servers, which are respectively numbered as H0 to H15. The target cluster is divided into four Pods, which are respectively numbered as Pod 0 to Pod 3.

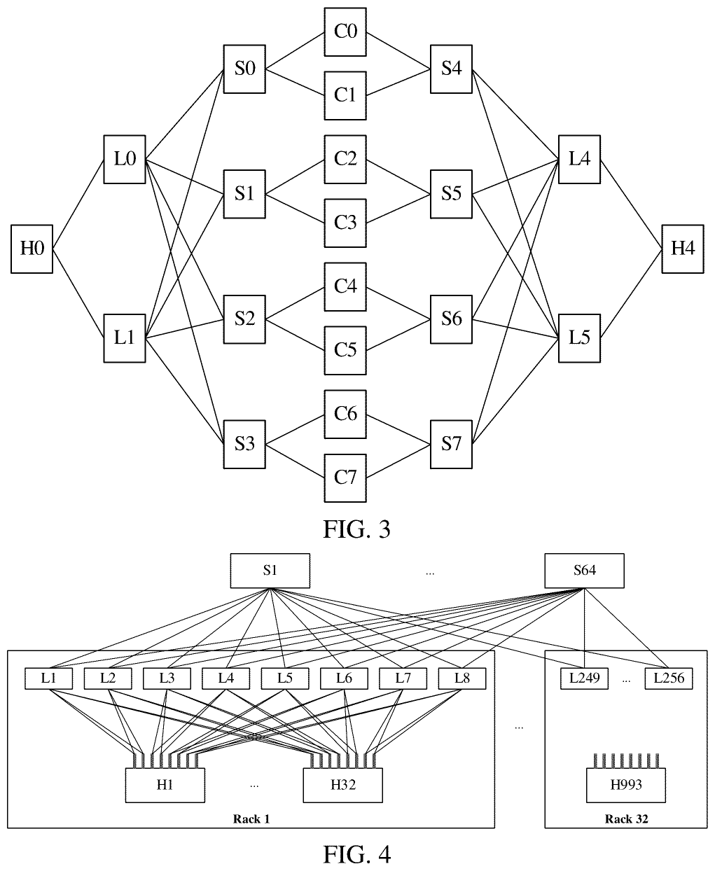

As shown in FIG. 3, for one server group, one server group includes two servers, and in the network topology diagram in FIG. 2, there may be a plurality of paths in one server pair.

Certainly, in another embodiment, a topology structure of the target cluster may alternatively be a Fat-Tree topology, a Clos topology, or an extended single Pod topology. Fat-Tree may be considered as a specific example of the Clos topology. In a common Clos topology, all aggregation-layer switches of each Pod are connected to all core-layer switches. The extended single Pod topology is shown in FIG. 4.

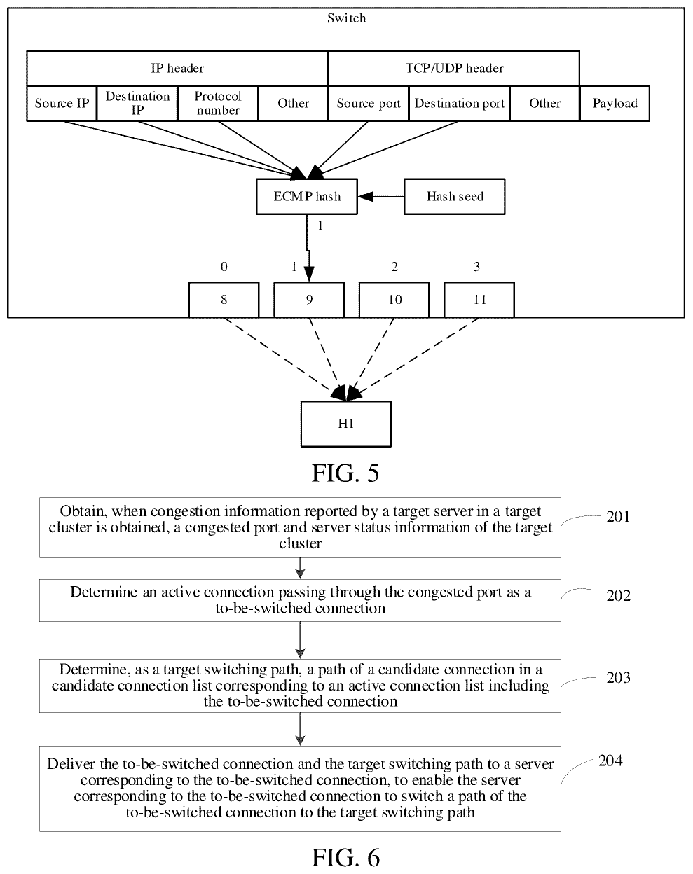

As shown in FIG. 5, the switch stores a hash function and a hash seed. The hash function is configured for calculating a hash output value based on a tuple identifier group of a data packet and the hash seed. Specifically, the tuple identifier group of the data packet is a five-tuple identifier group. Specifically, in the related art, the hash function in the switch is an equal-cost-multi-path (ECMP) hash function, and routing addressing is performed on the data packet by using the ECMP hash function. Generally, on a switch, there may be a plurality of paths of equal length leading to the same destination server. The length herein is a quantity of link hops, and is not a physical distance. When a data packet destined for the destination server reaches the switch, the switch needs to select one of a plurality of candidate egress ports, to send the data packet through the port. For the switch L0 in FIG. 2, it can be seen that four candidate egress ports may all lead to a server H3, and the four candidate egress ports respectively correspond to four aggregation-layer switches at the aggregation layer. When the egress port is selected, in ECMP hash, the five-tuple identifier group (a source IP, a destination IP, a protocol number of an IP header, and a source port and a destination port of either a TCP or UDP header) are extracted from the data packet for hash calculation. As shown in FIG. 5, data packets of the same flow (a data packet set having the same five-tuple) reach the destination server along the same path according to a sequence from which the data packets are sent. A result obtained through hash calculation is an index number of a candidate egress port list rather than a port number. The candidate egress port list is [8, 9, 10, 11], and a result 1 obtained through hash calculation represents a port whose index is 1 (the index number is calculated from 0) in the candidate egress port list, that is, a port 9.

In addition, the cluster load balancing system may further include a memory, which may be used to store computer instructions (e.g., executable processor instructions), original data, intermediate data, and result data for various processes, such as computing process.

In embodiments of this disclosure, the memory may be a cloud storage. The cloud storage is a new concept extended and developed from a concept of cloud computing. A distributed cloud storage system (referred to as a storage system for short below) is a storage system integrating, through functions such as a cluster application, a grid technology, and a distributed access file system, a large quantity of different types of storage devices (where the storage device is also referred to as a storage node) in a network through application software or an application interface, to work collaboratively and jointly provide data storage and service access functions to the outside.

Currently, a storage method of the storage system is to create a logical volume. During creation of logical volumes, physical storage space is allocated for each logical volume. The physical storage space may be a combination of magnetic disks of a specific storage device or several storage devices. A client stores data in a logical volume, that is, stores data in a file system. The file system divides data into many segments, and each segment is an object. The object includes not only data, but also additional information such as an ID entity (ID) of the data. The file system writes each object into physical storage space of the logical volume, and records storage location information of each object. In this way, when the client requests to access the data, the file system enables the client to access the data based on the storage location information of each object.

A specific process in which the storage system allocates physical storage space to a logical volume includes: The physical storage space is divided into stripes in advance according to an estimated capacity (which usually has a large margin relative to a capacity of an object that actually needs to be stored) of an object stored in a logical volume and grouping of a redundant array of independent disk (RAID), and one logical volume may be understood as one stripe. In this way, the physical storage space is allocated for the logical volume.

A schematic diagram of a scenario of the cluster load balancing system shown in FIG. 1 is merely an example. The cluster load balancing system described in this embodiment of this disclosure is intended to describe the technical solutions in embodiments of this disclosure more clearly, and does not constitute a limitation on the technical solutions provided in embodiments of this disclosure. A person of ordinary skill in the art may learn that, with evolution of the cluster load balancing system and emergence of new service scenarios, the technical solutions provided in embodiments of this disclosure are also applicable to similar technical problems.

Details are separately described below. Sequence numbers of the following embodiments are not intended to limit a preference sequence of embodiments.

FIG. 6 is a schematic flowchart of an embodiment of a cluster load balancing method according to an embodiment of this disclosure. As shown in FIG. 6, the cluster load balancing method is applied to a centralized controller. The centralized controller may be located in a target cluster, or may be located outside the target cluster. A procedure of the cluster load balancing method provided in this application is as follows.

201: Obtain, when congestion information reported by a target server in the target cluster is obtained, a congested port and server status information of the target cluster.

The target cluster includes a plurality of servers and a plurality of switches, the switch includes a plurality of switch ports, and the target server may be any server in the target cluster.

In this embodiment of this disclosure, the server status information includes an active connection list between the servers and a corresponding candidate connection list. The active connection list includes a plurality of active connections, the candidate connection list includes a plurality of candidate connections, and each candidate connection in the candidate connection list is a standby connection of the active connection list.

The active connection and the candidate connection both include paths, and the path includes switches that the connection passes. For example, a server group includes H0 and H3, and a path of an active connection of the server group is L0->S0->L2, indicating that a data packet is transmitted between the server H0 and the server H3 through the path L0->S0->L2 in the active connection. The server H0 sequentially passes data through the switch L0, the switch S0, the switch L2, until the data finally reaches the server H3.

The congestion information is notification information indicating that a congested connection (or congestion condition) occurs in the target cluster. If discovering a congested connection (or congestion condition), the server in the target cluster may report congestion information to the centralized controller. The servers in the target clusters establish active connections. The server detects whether a congested connection (or congestion condition) exists in the active connections, and sends the congestion information to the centralized controller when the congested connection (or congestion condition) exists in the active connections. The congested port is a switch port that is known to be congested. The centralized controller may determine, based on related information reported by the switch, whether there is a congested port.

In this embodiment of this disclosure, the server status information is reported by the server at a preset period. The preset period may be 0.1 s, 0.2 s, or the like, and may be set depending on a specific situation.

202: Determine an active connection passing through the congested port as a to-be-switched connection.

In this embodiment of this disclosure, switch ports through which paths of all the active connections pass are obtained, and the active connection passing through the congested port is determined as the to-be-switched connection.

For example, the target cluster is an AI training cluster network. The AI training cluster network is usually configured with non-convergent bandwidths, to be specific, a sum of downlink bandwidths of switches at each layer is equal to a sum of uplink bandwidths, to expect to eliminate a throughput bottleneck in the training network. However, due to reasons such as a single-connection path and imbalanced routing hash, an actual data flow may usually be congested in a network to some extent, resulting in that these theoretically non-convergent bandwidths cannot be completely used. Congestion types include the following types.

Leaf uplink congestion: Traffic of a plurality of servers in the same rack is hashed to the same uplink port during Leaf uplink routing hash. For example, H0->L0->S0->L2->H2 and H1->L0->S0->L2->H3 are congested at an uplink port of L0.

Spine uplink congestion: Traffic of a plurality of servers in the same Pod is hashed to the same uplink port during Spine uplink routing hash. For example, H0->L0->S0->C0->S4->L4->H4 and H2->L3->S0->C0->S8->L8->H8 are congested at an uplink port of S0

Core downlink congestion: When traffic from one Pod or a plurality of Pods is sent to the same Pod, the traffic may be hashed to the same downlink port during Core downlink routing hash. For example, H0->L0->S0->C0->S4->L4->H4 and H8->L8->S8->C0->S4->L5->H5 are congested at a downlink port of C0.

Spine downlink congestion: Traffic across Pods or racks is hashed to the same downlink port during Spine downlink routing hash. For example, H2->L2->S0->L0->H0 and H3->L3->S0->L0->H0 are congested at a downlink port of S0.

Leaf downlink congestion: Traffic sent to the same node is congested at a Leaf downlink port. This type of congestion is usually because the receiving side Spine does not balance traffic to two Leaf layers during downlink. For example, H0->L0->S0->L2->H2 and H0->L1->S1->L2->H2 are congested at a downlink port of L2.

When there is congestion during sending, throughput of a connection is apparently damaged, and is usually reduced by more than 50%. In this case, a plurality of parallel connections between a node pair may be delayed by a congested connection (or congestion condition) (where the connections need to wait until transmission of the congested connection is completed), leading to a severe increase in communication completion time of the node pair. Because AI training has an apparently serial feature and synchronization requirement, network congestion finally severely affects throughput of the entire cluster. It can be learned that training performance of the cluster is closely related to the congestion of the network, and a small amount of congestion of the network causes the performance of the entire cluster to be severely reduced.

For example, traffic of a plurality of servers is hashed to the same uplink port during uplink routing hash of the switch L0. For example, if paths of two active connections are respectively H0->L0->S0->L2->H2 and H1->L0->S0->L2->H3, the paths of the two active connections are congested at the uplink port of the switch L0, the uplink port of the switch L0 is a congested port, and the paths of the two active connections both pass through the congested port.

203: Determine, as a target switching path, a path of a candidate connection in a candidate connection list corresponding to an active connection list including the to-be-switched connection.

In a specific embodiment, a path of a candidate connection in the candidate connection list is randomly determined as the target switching path.

In another specific embodiment, throughput of each candidate connection in the candidate connection list is obtained, and a path of a candidate connection having smallest throughput is determined as the target switching path. A path with small throughput usually means a current load is light. Selection of such a path for switching helps to reduce network congestion and improve data transmission efficiency and stability. In another embodiment, a path of a candidate connection, which is selected from the candidate connection list, may be determined as the target switching path in another manner. This is not limited in this application.

204: Deliver the to-be-switched connection and the target switching path to a server corresponding to the to-be-switched connection, to enable the server corresponding to the to-be-switched connection to switch a path of the to-be-switched connection to the target switching path.

In this embodiment of this disclosure, after the to-be-switched connection and the target switching path are determined, the server corresponding to the to-be-switched connection is determined based on the server status information, and the to-be-switched connection and the target switching path are sent to the server corresponding to the to-be-switched connection, so that the path of the to-be-switched connection is switched to the target switching path.

In this way, when sensing congestion based on the congestion information uploaded by the server, the centralized controller obtains a congested switch port (that is, the congested port), uses the active connection passing through the congested port as the to-be-switched connection, and selects, for switching, the path of the candidate connection from the candidate connection list corresponding to the active connection list including the to-be-switched connection. This can effectively alleviate or eliminate network congestion. The centralized controller is used to comprehensively process congestion information of each server and the congested port uploaded by the switch, and centralized flow scheduling is used to eliminate network congestion, so that a cluster load balancing degree and bandwidth utilization can be improved.

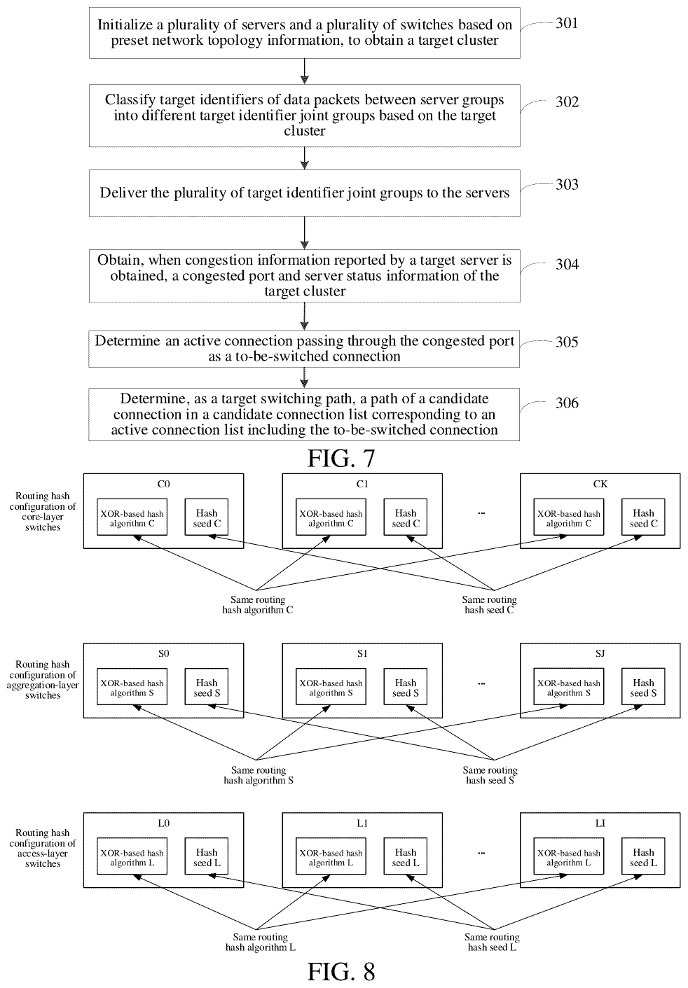

FIG. 7 is a schematic flowchart of another embodiment of a cluster load balancing method according to an embodiment of this disclosure. As shown in FIG. 7, a procedure of the cluster load balancing method provided in this application is as follows.

301: Initialize a plurality of servers and a plurality of switches based on preset network topology information, to obtain a target cluster.

In this embodiment of this disclosure, the preset network topology information includes a network topology structure. The network topology structure may be a Fat-Tree topology, a Clos topology, or an extended single Pod topology. Specifically, a network topology structure of the target cluster is shown in FIG. 2.

In this embodiment of this disclosure, the preset network topology information includes routing hash configuration of each switch layer, and the routing hash configuration includes a hash function and a hash seed. Specifically, the same hash function and hash seed are used at the same switch layer, and different hash functions and hash seeds are used at different switch layers. In this way, the same hash function and hash seed are used at the same switch layer, so that data packets are evenly distributed to switches at the same layer in a forwarding process, thereby achieving load balancing. The different hash functions and hash seeds are used at the different switch layers, so that isolation of data between different layers can be improved, thereby helping improve network security. The different hash functions and hash seeds are used at the different switch layers, so that flexibility of a network design is also improved. A network administrator may adjust selection of the hash function and the hash seed based on an actual requirement, to adapt to different network environments and service requirements. In some implementations, for each switch layer, the hash functions and hash seeds are mutually distinct.

As shown in FIG. 8, specifically, in this application, switches at the same layer all use an exclusive OR (XOR)-based hash function. For example, the exclusive OR (XOR)-based hash function may be a CRC32 algorithm, toeplitz matrix, or the like. In addition, the switches at the same layer use the same hash seed. For example, all access-layer switches at a Leaf layer use the same exclusive-OR-based hash algorithm L and hash seed L, all aggregation-layer switches at a Spine layer use an exclusive-OR-based hash algorithm S and a hash seed S, and all core-layer switches at a core layer use an exclusive-OR-based hash algorithm C and a hash seed C. In practice, basically, all modern data center switches support an exclusive-OR-based hash method, and therefore, this requirement can be met in all switches.

302: Classify target identifiers of data packets between server groups into different target identifier joint groups based on the target cluster.

A data packet belonging to the target identifier joint group is transmitted between the server groups along a flowing path corresponding to the target identifier joint group, and the flowing path includes a plurality of switch ports. One target identifier joint group corresponds to one flowing path. For example, the flowing path is L0->S0->L2, indicating that the data packet is sequentially transmitted between the server groups through a switch port of the switch L0, a switch port of the switch S0, and a switch port of the switch L2.

In this embodiment of this disclosure, the target identifier may include a source port number of the data packet. In another embodiment, the target identifier may include a part of bits (for example, least significant or most significant 8 bits) of a source port number. In IPv4 network routing, in a five-tuple participating in routing hash calculation, only a source port number is freely variable (which is not limited), and the other four elements are limited. Therefore, the source port number or a partial field of the source port number is used as the target identifier, so that it can be ensured that all source port numbers in the same target identifier group can generate same output of a hash function. A path of a data flow is controlled by configuring a target identifier of the data flow, to avoid congestion. In addition, in IPv6 network routing, there are more choices to identify a logic path, provided that a field is freely variable and participates in routing hash calculation. For example, the target identifier is a flow label field of an IPv6 packet header or a part of bits of the flow label field.

In a specific embodiment, to improve grouping efficiency, the target cluster includes a plurality of switch layers, each switch layer includes a plurality of switches, and classifying the target identifiers of the data packets between the server groups into different target identifier groups based on the target cluster includes the following operations.

(1) The target identifiers of the data packets between the server groups are respectively classified into the different target identifier groups based on the switch layers By way of example, where the source port number serves as the target identifier, packets having a target identifier of 1 are classified into a first target-identifier group, and packets having a target identifier of 2 are classified into a second target-identifier group, wherein packets with different target identifiers are classified into different target-identifier groups.

In this embodiment of this disclosure, that the target identifiers of the data packets between the server groups are respectively classified into the different target identifier groups based on the switch layers includes: inputting test data packets having different tuple identifiers transmitted or exchanged between the server groups to the switch layer, to obtain a switch port corresponding to each test data packet, where the tuple identifier includes a target identifier, and target identifiers in the tuple identifiers are different; and placing target identifiers of tuple identifiers of test data packets of the same switch port into the same target identifier group, to obtain a plurality of target identifier groups. In some implementations, target identifiers in different tuple identifiers are mutually distinct.

In this embodiment of this disclosure, the test data packets having different tuple identifiers between the server groups may be generated by a first preset tool. After the test data packets having different tuple identifiers between the server groups are input to the switch layer, detection is performed by using the first preset tool, to obtain the switch port corresponding to each test data packet.

The first preset tool may be a traceroute tool. Traceroute is an important network diagnosis tool, and can help a developer identify a connection problem, a bottleneck point, and a data packet loss in a network. The tool detects a path of a data packet from a source computer to a destination, and provides detailed information about each intermediate hop by identifying hosts along the path. Traceroute is intended to provide the developer with a clear picture of the path of the data packet through the network. This is implemented by using a time-to-live (TTL) field in a header of the data packet. The field specifies a quantity of hops that the data packet can make before the data packet is discarded. The traceroute tool sends a data packet having a TTL value that gradually increases from 1, and records, by repeating this process, a host that receives an internet control message protocol (ICMP) TTL exceeded message. The tool may construct a network map and identify each hop that the data packet passes before the data packet reaches a destination. Traceroute has several key features, which make traceroute a necessary tool of the developer. Data packet timing: Traceroute records time needed by each data packet from a source to a destination, and allows the developer to identify a slow point or a bottleneck point in the network. Reverse domain name system (DNS) lookup: Traceroute performs reverse DNS lookup for each hop to parse an IP address into a host name, so as to identify a network device on a path more easily. Customizable parameter: Traceroute allows the developer to customize a data packet size, a port number, and a TTL value, to provide more flexibility for resolving a network problem. To use Tracerute, only a command prompt or a terminal window needs to be opened and Tracerute is entered, then an IP address or a host name of a target is entered, and another option such as a maximum TTL value or a data packet size may be further added.

An underlying principle of relative path control is that output of the exclusive OR (XOR)-based hash function has a linear feature in an exclusive OR sense for an input offset. In other words, the same input offset may generate the same output offset (regardless of a non-offset part). In this application, output of a network routing hash function is controlled by controlling input (the target identifier) of the network routing hash function, to obtain the target identifier group that can generate different output. Finally, a centralized controller configures the target identifier of the data flow to control the path of the data flow, to avoid congestion.

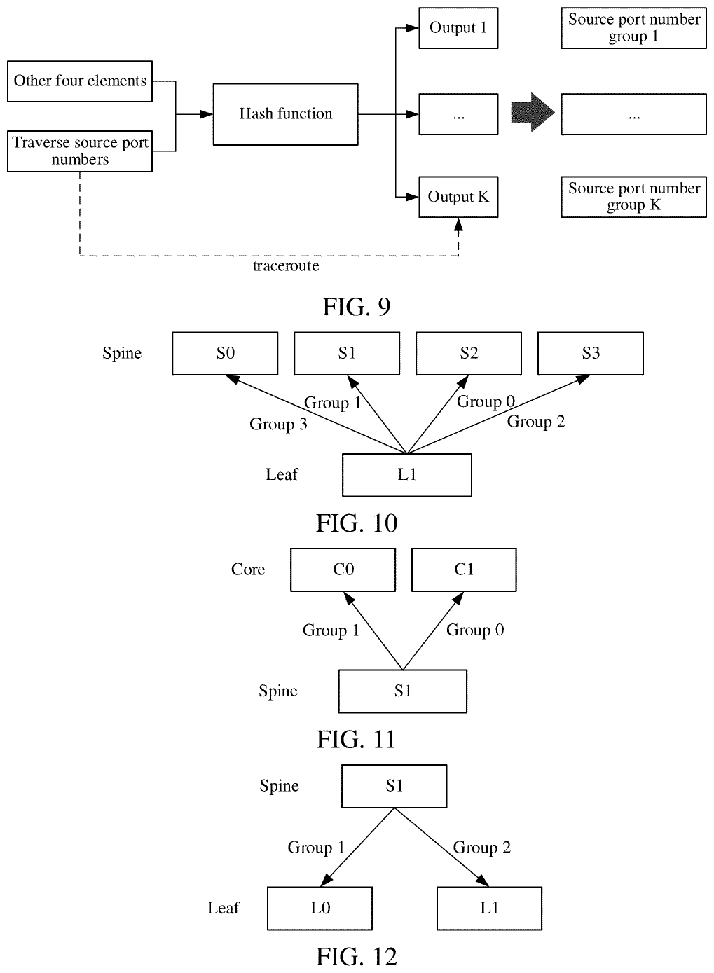

As shown in FIG. 9, an example in which the tuple identifier is a five-tuple and the target identifier is a source port number in the five-tuple is used. The other four elements in the five-tuple are kept unchanged, source port numbers are traversed to obtain a plurality of different five-tuple identifiers, the plurality of different five-tuple identifiers are input into the hash function at the switch layer, to obtain hash offsets of the five-tuple identifiers. Source port numbers in five-tuple identifiers having the same hash offset are placed into the same source port number group. In these groups, all source port numbers in the same group may generate the same hash function offset.

The source port numbers are grouped, so that efficiency of alternative path detecting can be improved. If the network has no relative path control capability, when an alternative connection path is detected or a new path is detected for a congested active path, source port numbers need to be traversed to be detected one by one. In this case, detection efficiency is very low, and a new available path may not be detected. However, with the relative path control capability, a quantity of paths that are partially overlapping or completely non-overlapping can be clearly known, and which source port numbers can correspond to these paths can be calculated.

In another embodiment, the test data packets having different tuple identifiers between the server groups may be generated by using a virtual router. In other words, on the switch, a five-tuple is input to a virtual routing function, to obtain a hash result. For example, on an aggregation-layer switch, all five-tuples are traversed to obtain output of the virtual routing function, a modulo operation is performed on a quantity of candidate egress ports based on the output, and then source port numbers having the same remainder are grouped into one group, to obtain a corresponding group.

In this embodiment of this disclosure, the target cluster includes an access layer, an aggregation layer, and a core layer.

As shown in FIG. 10, the target identifiers of the data packets between the server groups are first classified into different target identifier groups based on the aggregation layer. Based on the method described in FIG. 9, source port number groups hashed on a switch at the access layer Leaf to different aggregation-layer switches may be obtained, and are represented by spine group indexes (SGis), for example, an SG 0, an SG 1, an SG 2, and an SG 3. The obtained group may be determined to be routed to different aggregation-layer switches.

As shown in FIG. 11, the target identifiers of the data packets between the server groups are classified into different target identifier groups based on the core layer. Similarly, source port number groups hashed at the aggregation-layer switch to different core-layer switches may be obtained, and are represented by core group indexes (CGis), for example, a CG 0 and a CG 1.

As shown in FIG. 12, the target identifiers of the data packets between the server groups are classified into different target identifier groups based on the access layer. Similarly, source port number groups hashed at the aggregation-layer switch to different access-layer switches may be obtained, and are represented by leaf group indexes (LGis), that is, an LG 0 and an LG 1.

(2) Target identifier groups at different switch layers are combined to obtain a plurality of target identifier joint groups.

A target identifier in the target identifier joint group is an intersection set of target identifiers in the target identifier groups included in the target identifier joint group.

In this embodiment of this disclosure, after the target identifier group of each layer of switches is obtained, a target identifier joint group of multi-layer switches may be further obtained through processing. The target identifier joint group may be obtained by performing intersection in pairs on the target identifier groups at different layers.

Specifically, the target identifier is a source port number. After a source port number group of each layer of switches is obtained, a source port number joint group of multi-layer switches may be further obtained through processing. Two or more types of joint groups may be obtained by intersecting two or more types of groups in pairs. For example, based on the topology in FIG. 2, source port number groups of four aggregation layers, source port number groups of two core layers, and source port number groups of two access layers may be obtained. The source port number groups of the four aggregation layers and the source port number groups of the two core layers intersect with each other in pairs, to obtain eight Spine-Leaf (SL) joint groups. A source port number in each group corresponds to a path passing a specific aggregation-layer switch and access-layer switch, and there are eight different paths in total. Further, intersection is performed twice on the source port numbers of the four aggregation layers, the source port numbers of the two core layers, and the source port numbers of the two access layers, to obtain 16 Spine-Core-Leaf (SCL) joint groups, that is, 16 target identifier joint groups. A source port number of each group corresponds to a path passing a specific Spine-Core-Leaf switch, and there are 16 different paths in total.

The target identifier joint group mainly functions in one server group, and can balance connection traffic in an IP pair to the network. However, traffic of different server groups cannot be handled simply through joint grouping, but needs to be handled through path rescheduling by using the centralized controller. An extreme case herein is an exception. To be specific, the server group uses enough connections, and all SCL groups can be covered. In this way it can be ensured that traffic at a granularity of the server group is load balanced in the entire network, so that mixed traffic of all server groups is also load balanced in the entire network without congestion.

303: Deliver the plurality of target identifier joint groups to the servers.

In this embodiment of this disclosure, to control a path accurately enough when the server detects a path of a candidate connection, a joint group needs to be used as input of candidate connection detection, because complexity of network traffic and a congestion point may occur on any switch and it is hoped that a path can be controlled to any switch combination path. Therefore, the plurality of target identifier joint groups are delivered to the servers, so that the server can detect the path of the candidate connection more accurately.

304: Obtain, when congestion information reported by a target server is obtained, a congested port and server status information of the target cluster.

The target server may be any server in the target cluster.

In this embodiment of this disclosure, the server status information includes an active connection list between the servers and a corresponding candidate connection list. The active connection list includes a plurality of active connections, the candidate connection list includes a plurality of candidate connections, and each candidate connection in the candidate connection list is a standby connection of the active connection list. Specifically, the candidate connection list is configured for maintaining candidate connection information. The candidate connection list includes a target identifier and a path. The candidate connection list is mainly used after congestion is sensed, and the centralized controller delivers a path switching decision, and selects a path from the candidate connection list for switching.

In this embodiment of this disclosure, obtaining the congested port and the server status information of the target cluster includes: obtaining locally maintained switch status information, the switch status information including a congestion status of each switch port, and the switch status information being uploaded by each switch of the target cluster at a preset period; and determining the congested port based on the switch status information. In this embodiment of this disclosure, a congested port reported by the switch is determined as the congested port. The switch status information is regularly reported by each switch of the target cluster, and has high accuracy. The congested port is determined based on a switch status, so that accuracy of the congested port can be ensured.

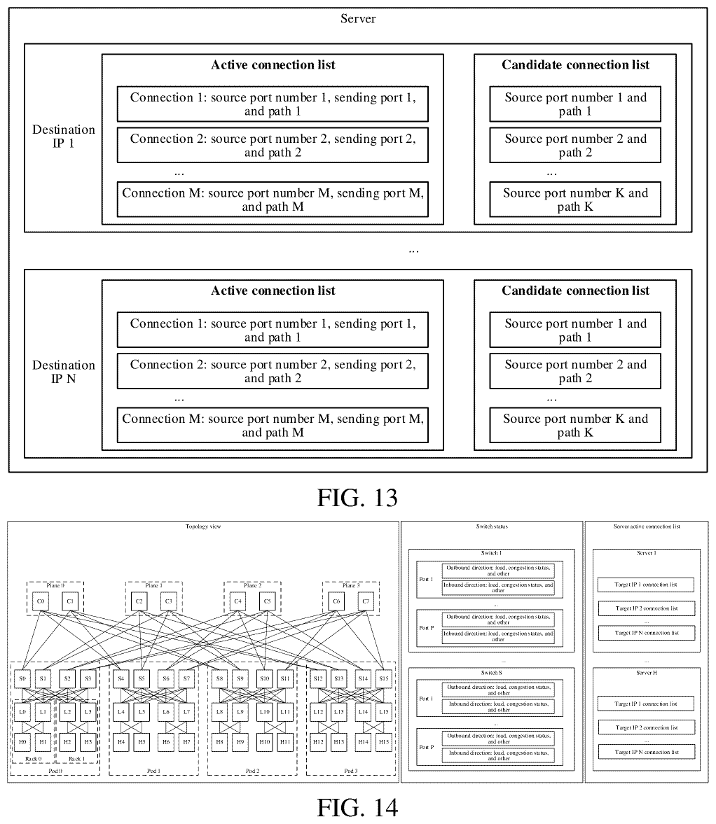

As shown in FIG. 13, the target identifier is a source port number. The active connection includes a source port number, a sending port, and a path. For example, active connection lists are respectively maintained between the server and a destination IP 1, a destination IP 2, . . . , and a destination IP N. The active connection list between the server and the destination IP 1 includes: a connection 1: a source port number 1, a sending port 1, and a path 1; a connection 2: a source port number 2, a sending port 2, and a path 2; a connection 3: a source port number 3, a sending port 3, and a path 3; . . . ; and a connection M: a source port number M, a sending port M, and a path M. Candidate connection lists corresponding to the active connection lists are respectively maintained between the server and the destination IP 1, the destination IP 2, . . . , and the destination IP N. The candidate connection list between the server and the destination IP 1 includes: a connection 1: a source port number 1 and a path 1; a connection 2: a source port number 2 and a path 2; a connection 3: a source port number 3 and a path 3; . . . ; and a connection K: a source port number K and a path K. K and M are both integers.

In this embodiment of this disclosure, the centralized controller obtains the switch status information at the preset period. The switch status information includes a load and congestion status of each switch port of each switch.

As shown in FIG. 14, the centralized controller obtains the switch status information and the server status information at a period, and maintains the switch status information, the server status information, and a topology view of the target cluster locally. The topology view of FIG. 14 is the same as that of FIG. 2.

As shown in FIG. 14, the switch status information includes statuses of ports of a switch 1 to a switch S. For example, status information of the switch 1 includes: a load, a congestion status, and the like in an outbound direction of a port 1, a load, a congestion status, and the like in an outbound direction of a port 2, . . . , and a load in an outbound direction of a port P.

305: Determine an active connection passing through the congested port as a to-be-switched connection.

In this embodiment of this disclosure, switch ports through which paths of all the active connections pass are obtained, and the active connection passing through the congested port is determined as the to-be-switched connection.

306: Determine, as a target switching path, a path of a candidate connection in a candidate connection list corresponding to an active connection list including the to-be-switched connection.

In a specific embodiment, a path of a candidate connection in the candidate connection list is randomly determined as the target switching path.

In another specific embodiment, throughput of each candidate connection in the candidate connection list is obtained, and a path of a candidate connection having smallest throughput is determined as the target switching path. In another embodiment, a path of a candidate connection, which is selected from the candidate connection list, may be determined as the target switching path in another manner. This is not limited in this application.

307: Deliver the to-be-switched connection and the target switching path to a server corresponding to the to-be-switched connection, to enable a path of the to-be-switched connection to be switched to the target switching path.

In this embodiment of this disclosure, after the to-be-switched connection and the target switching path are determined, the server corresponding to the to-be-switched connection is determined based on the server status information, and the to-be-switched connection and the target switching path are sent to the server corresponding to the to-be-switched connection, so that the path of the to-be-switched connection is switched to the target switching path.

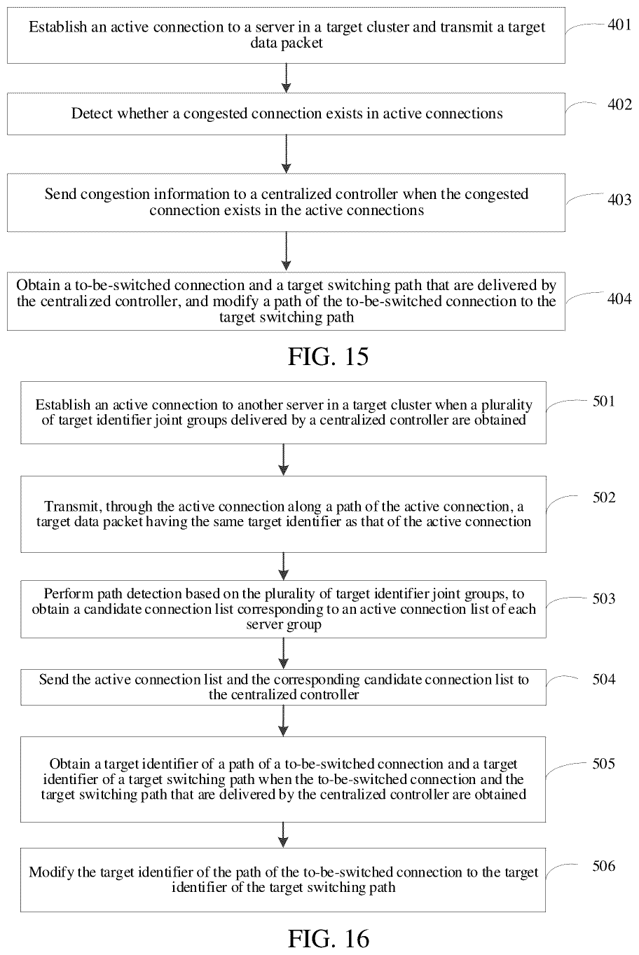

FIG. 15 is a schematic flowchart of still another embodiment of a cluster load balancing method according to an embodiment of this disclosure. As shown in FIG. 15, the cluster load balancing method is applied to a server in a target cluster. A procedure of the cluster load balancing method provided in this application is as follows.

401: Establish an active connection to the server in the target cluster and transmit a target data packet.

In this embodiment of this disclosure, an active connection in an active state is recorded in an active connection list. The active state indicates a connected state in which data is transmitted or data can be immediately transmitted. The active connection list includes a plurality of active connections, and each active connection includes a target identifier and a flowing path

402: Detect whether a congested connection (or congestion condition) exists in the active connections.

In a specific embodiment, when receiving a congestion packet sent back by a receiving end, the server determines whether the congested connection (or congestion condition) exists in the active connections. For example, the congestion packet is a congestion notification packet (CNP). Whether the congested connection (or congestion condition) exists in the active connections can be quickly determined depending on whether the congestion packet is received, to improve efficiency of determining the congested connection (or congestion condition).

In another specific embodiment, the server periodically measures a rate of each active connection, and when a rate of the active connection is lower than a preset rate, the server determines that the congested connection (or congestion condition) exists in the active connections. Whether the congested connection (or congestion condition) exists in the active connections can be accurately determined by measuring the rate of the active connection. The rate of the active connection is regularly measured, so that computer resources can be saved to some extent. The rate may comprise, for example, a data (or data packet) transmission rate, e.g., bits per second (bps), kilobits per second (kbps), megabits per second (Mbps), or gigabits per second (Gbps).

403: Send congestion information to a centralized controller when the congested connection (or congestion condition) exists in the active connections.

In this embodiment of this disclosure, when the congested connection (or congestion condition) exists in the active connections, it indicates that the server senses congestion, and reports related information about the congested connection (or congestion condition) to the centralized controller for positioning and path switching decision reference. The congestion information may include the congested connection (or congestion condition), or may not include the congested connection (or congestion condition). When receiving the congestion information, the centralized controller obtains a congested port and server status information of the target cluster. The server status information includes an active connection list between servers and a corresponding candidate connection list. The centralized controller determines an active connection passing through the congested port as a to-be-switched connection, and determines, as a target switching path, a path of a candidate connection in a candidate connection list corresponding to an active connection list including the to-be-switched connection.

404: Obtain the to-be-switched connection and the target switching path that are delivered by the centralized controller, and modify a path of the to-be-switched connection to the target switching path.

In this way, when discovering that the congested connection (or congestion condition) exists, the server reports the congested connection (or congestion condition) to the centralized controller in a timely manner. When sensing congestion based on the congestion information uploaded by the server, the centralized controller obtains a congested switch port (that is, the congested port), uses the active connection passing through the congested port as the to-be-switched connection, and selects, for switching, the path of the candidate connection from the candidate connection list corresponding to the active connection list including the to-be-switched connection. This can effectively alleviate or eliminate network congestion. The centralized controller is used to comprehensively process congestion information of each server and the congested port uploaded by the switch, and centralized flow scheduling is used to eliminate network congestion, so that a cluster load balancing degree and bandwidth utilization can be improved.

FIG. 16 is a schematic flowchart of still another embodiment of a cluster load balancing method according to an embodiment of this disclosure. As shown in FIG. 16, the cluster load balancing method is applied to a server in a target cluster. A procedure of the cluster load balancing method provided in this application is as follows:

501: Establish an active connection to another server in the target cluster when a plurality of target identifier joint groups delivered by a centralized controller are obtained.

The active connection includes a target identifier and a path.

In this embodiment of this disclosure, when the plurality of target identifier joint groups delivered by the centralized controller are obtained, the active connection is established to the another server in the target cluster. The active connection includes the target identifier and the path.

502: Transmit, through the active connection along a path of the active connection, a target data packet having the same target identifier as that of the active connection.

In this embodiment of this disclosure, different active connections are configured for transmitting different data packets, to improve data packet transmission efficiency. A plurality of different connections in a server group pass through different aggregation switches and are evenly distributed on access switches on a receiving side.

503: Perform path detection based on the plurality of target identifier joint groups, to obtain a candidate connection list corresponding to an active connection list of each server group.

The active connection list of the server group includes active connections established between server groups. A target identifier joint group of each candidate connection in the candidate connection list is different from a target identifier joint group of each active connection in the active connection list. Because different target identifier joint groups correspond to different paths, a path of each candidate connection in the candidate connection list is different from a path of each active connection in the active connection list.

In this embodiment of this disclosure, after the active connection is established to the another server in the target cluster, path detection is performed on paths corresponding to the plurality of target identifier joint groups, to obtain the candidate connection list corresponding to the active connection list of each server group.

Specifically, the candidate connection list is configured for maintaining candidate connection information. The candidate connection list includes a target identifier and a path. The candidate connection list is mainly used after congestion is sensed, and the centralized controller delivers a path switching decision, and selects a path from the candidate connection list for switching.

As shown in FIG. 13, the target identifier is a source port number. The candidate connection includes a source port number, a sending port, and a path. For example, candidate connection lists corresponding to active connection lists are respectively maintained between the server and a destination IP 1, a destination IP 2, . . . , and a destination IP N. The candidate connection list between the server and the destination IP 1 includes: a connection 1: a source port number 1 and a path 1; a connection 2: a source port number 2 and a path 2; a connection 3: a source port number 3 and a path 3; . . . ; and a connection K: a source port number K and a path K.

Specifically, path detection is performed based on the plurality of target identifier joint groups by using an in-band network telemetry (INT) tool, to obtain the candidate connection list corresponding to the active connection list of each server group. Target identifiers in the target identifier joint group are input to the INT tool, to obtain paths of the target identifiers in the target identifier joint group that are detected by the INT tool. A path of the active connection is removed from the detected paths of the target identifiers in the target identifier joint group, to obtain a candidate path. The candidate connection is determined based on the candidate path and a corresponding source port number.

A common practice of INT is to insert an operation, administration, and maintenance (OAM) layer between a header of a data packet and internal data of the data packet. In this case, the data packet changes from an ordinary network data packet to a data packet with a “mark”. In-band operation, administration, and maintenance (IOAM) is a network measurement technology. In IOAM, service traffic is sampled in real time and at a high speed, and IOAM information (Metadata, including a device ID, input and output interfaces, a time stamp, and the like) is added to sampled data, and then the sampled data is actively sent to an analyzer for analysis, to implement real-time sensing of a network running status. An INT function is used to detect a physical path of a packet having a specific five-tuple in a network. A complete path form is, for example, (a sending side) Leaf->(a sending side) Spine->Core->(a receiving side) Spine->(a receiving side) Leaf. For example, the physical path is L0->S0->C0->S4->L4.

504: Send the active connection list and the corresponding candidate connection list to the centralized controller.

In this embodiment of this disclosure, the server maintains the active connection list and the corresponding candidate connection list locally, and sends the active connection list and the corresponding candidate connection list to the centralized controller. In this way, different target identifier joint groups correspond to different paths, and the accurate candidate connection list corresponding to the active connection list may be obtained by performing path detection based on the target identifier joint groups. After sensing congestion, the centralized controller delivers a path switching decision to select a path from the candidate connection list for switching, to eliminate network congestion and improve a cluster load balancing degree and bandwidth utilization.

The server may send the active connection list and the corresponding candidate connection list to the centralized controller at a preset period. In this way, the active connection list and the corresponding candidate connection list are updated regularly, so that timeliness of the active connection list and the corresponding candidate connection list is ensured. In this way, when sensing congestion, the centralized controller can select a path for switching based on latest data, to ensure switching accuracy, so as to eliminate network congestion and improve the cluster load balancing degree and the bandwidth utilization.

505: Obtain a target identifier of a path of the to-be-switched connection and a target identifier of the target switching path when the to-be-switched connection and the target switching path that are delivered by the centralized controller are obtained.

In this embodiment of this disclosure, the target identifier is a source port number.

506: Modify the target identifier of the path of the to-be-switched connection to the target identifier of the target switching path.

In this embodiment of this disclosure, when the target identifier of the path of the to-be-switched connection is modified, because the target identifier is modified, a path of a corresponding data flow is modified to the target switching path, so that the path of the to-be-switched connection is modified, to implement load balancing.

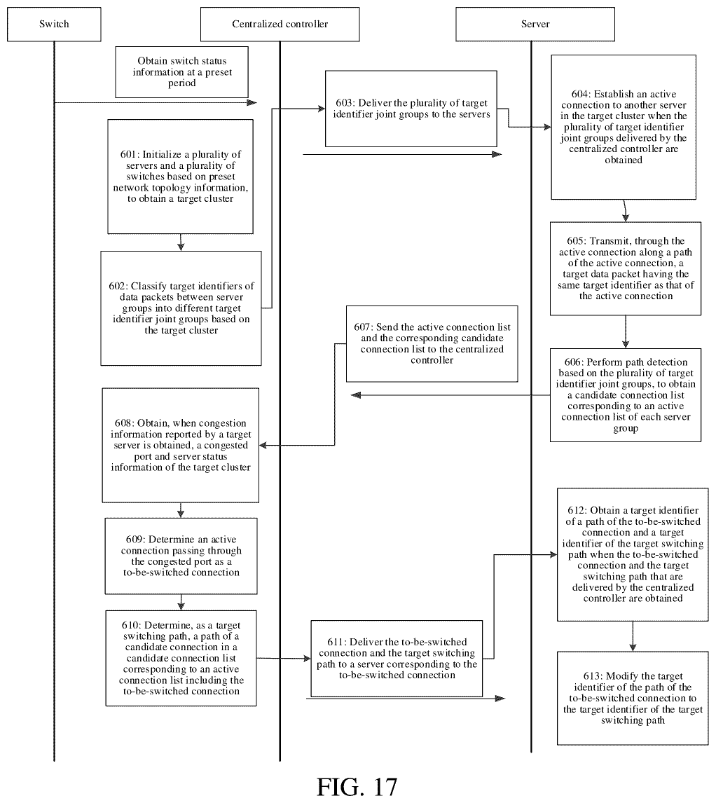

FIG. 17 is a schematic flowchart of still another embodiment of a cluster load balancing method according to an embodiment of this disclosure. As shown in FIG. 17, a procedure of the cluster load balancing method provided in this application is as follows:

601: Initialize a plurality of servers and a plurality of switches based on preset network topology information, to obtain a target cluster.

In this embodiment of this disclosure, a centralized controller initializes the plurality of servers and the plurality of switches based on the preset network topology information, to obtain the target cluster. The centralized controller obtains switch status information at a preset period.

In this embodiment of this disclosure, the preset network topology information includes a network topology structure. The network topology structure may be a Fat-Tree topology, a Clos topology, or an extended single Pod topology. Specifically, a network topology structure of the target cluster is shown in FIG. 2.

In this embodiment of this disclosure, the preset network topology information includes routing hash configuration of each switch layer, and the routing hash configuration includes a hash function and a hash seed. Specifically, the same hash function and hash seed are used at the same switch layer, and different hash functions and hash seeds are used at different switch layers.

602: Classify target identifiers of data packets between server groups into different target identifier joint groups based on the target cluster.

In this embodiment of this disclosure, the centralized controller classifies the target identifiers of the data packets between the server groups into the different target identifier joint groups based on the target cluster.

603: Deliver the plurality of target identifier joint groups to the servers.

In this embodiment of this disclosure, the centralized controller delivers the plurality of target identifier joint groups to the servers.

In this embodiment of this disclosure, to control a path accurately enough when the server detects a path of a candidate connection, a joint group needs to be used as input of candidate connection detection, because complexity of network traffic and a congestion point may occur on any switch and it is hoped that a path can be controlled to any switch combination path. Therefore, the plurality of target identifier joint groups are delivered to the servers, so that the server can detect the path of the candidate connection more accurately.

604: Establish an active connection to another server in the target cluster when the plurality of target identifier joint groups delivered by the centralized controller are obtained.

In this embodiment of this disclosure, when the plurality of target identifier joint groups delivered by the centralized controller are obtained, the server establishes the active connection to the another server in the target cluster.

The active connection includes a target identifier and a path.

As shown in FIG. 13, the target identifier is a source port number. The active connection includes a source port number, a sending port, and a path. For example, active connection lists are respectively maintained between the server and a destination IP 1, a destination IP 2, . . . , and a destination IP N. The active connection list between the server and the destination IP 1 includes: a connection 1: a source port number 1, a sending port 1, and a path 1; a connection 2: a source port number 2, a sending port 2, and a path 2; a connection 3: a source port number 3, a sending port 3, and a path 3; . . . ; and a connection M: a source port number M, a sending port M, and a path M.

In this embodiment of this disclosure, when the plurality of target identifier joint groups delivered by the centralized controller are obtained, the active connection is established to the another server in the target cluster. The active connection includes the target identifier and the path.

605: Transmit, through the active connection along a path of the active connection, a target data packet having the same target identifier as that of the active connection.

In this embodiment of this disclosure, the server transmits, through the active connection along the path of the active connection, the target data packet having the same target identifier as that of the active connection.

In this embodiment of this disclosure, different active connections are configured for transmitting different data packets. A plurality of different connections in a server group pass through different aggregation switches and are evenly distributed on access switches on a receiving side.

606: Perform path detection based on the plurality of target identifier joint groups, to obtain a candidate connection list corresponding to an active connection list of each server group.

In this embodiment of this disclosure, the server performs path detection based on the plurality of target identifier joint groups, to obtain the candidate connection list corresponding to the active connection list of each server group.

The active connection list of the server group includes active connections established between server groups. A target identifier joint group of each candidate connection in the candidate connection list is different from a target identifier joint group of each active connection in the active connection list. Because different target identifier joint groups correspond to different paths, a path of each candidate connection in the candidate connection list is different from a path of each active connection in the active connection list.

In this embodiment of this disclosure, after the active connection is established to the another server in the target cluster, path detection is performed on paths corresponding to the plurality of target identifier joint groups, to obtain the candidate connection list corresponding to the active connection list of each server group.

Specifically, the candidate connection list is configured for maintaining candidate connection information. The candidate connection list includes a target identifier and a path. The candidate connection list is mainly used after congestion is sensed, and the centralized controller delivers a path switching decision, and selects a path from the candidate connection list for switching.

607: Send the active connection list and the corresponding candidate connection list to the centralized controller.

In this embodiment of this disclosure, the server sends the active connection list and the corresponding candidate connection list to the centralized controller.

In this embodiment of this disclosure, the server maintains the active connection list and the corresponding candidate connection list locally, and sends the active connection list and the corresponding candidate connection list to the centralized controller at a preset period.

608: Obtain, when congestion information reported by a target server is obtained, a congested port and server status information of the target cluster.

In this embodiment of this disclosure, when the congestion information reported by the target server is obtained, the centralized controller obtains the congested port and the server status information of the target cluster.

The target server may be any server in the target cluster.

In this embodiment of this disclosure, the server status information includes an active connection list between the servers and a corresponding candidate connection list. The active connection list includes a plurality of active connections, the candidate connection list includes a plurality of candidate connections, and each candidate connection in the candidate connection list is a standby connection of the active connection list. Specifically, the candidate connection list is configured for maintaining candidate connection information. The candidate connection list includes a target identifier and a path. The candidate connection list is mainly used after congestion is sensed, and the centralized controller delivers a path switching decision, and selects a path from the candidate connection list for switching.

609: Determine an active connection passing through the congested port as a to-be-switched connection.

In this embodiment of this disclosure, the centralized controller determines the active connection passing through the congested port as the to-be-switched connection.

In this embodiment of this disclosure, switch ports through which paths of all the active connections pass are obtained, and the active connection passing through the congested port is determined as the to-be-switched connection.

610: Determine, as a target switching path, a path of a candidate connection in a candidate connection list corresponding to an active connection list including the to-be-switched connection.

In this embodiment of this disclosure, the centralized controller determines, as the target switching path, the path of the candidate connection in the candidate connection list corresponding to the active connection list including the to-be-switched connection.

In a specific embodiment, a path of a candidate connection in the candidate connection list is randomly determined as the target switching path.

In another specific embodiment, throughput of each candidate connection in the candidate connection list is obtained, and a path of a candidate connection having smallest throughput is determined as the target switching path. In another embodiment, a path of a candidate connection, which is selected from the candidate connection list, may be determined as the target switching path in another manner. This is not limited in this application.

611: Deliver the to-be-switched connection and the target switching path to a server corresponding to the to-be-switched connection, to enable a path of the to-be-switched connection to be switched to the target switching path.

In this embodiment of this disclosure, the centralized controller delivers the to-be-switched connection and the target switching path to the server corresponding to the to-be-switched connection, to enable the path of the to-be-switched connection to be switched to the target switching path.

612: Obtain a target identifier of a path of the to-be-switched connection and a target identifier of the target switching path when the to-be-switched connection and the target switching path that are delivered by the centralized controller are obtained.

In this embodiment of this disclosure, when the to-be-switched connection and the target switching path that are delivered by the centralized controller are obtained, the server obtains the target identifier of the path of the to-be-switched connection and the target identifier of the target switching path.

In this embodiment of this disclosure, the target identifier is a source port number.

613: Modify the target identifier of the path of the to-be-switched connection to the target identifier of the target switching path.

In this embodiment of this disclosure, the server modifies the target identifier of the path of the to-be-switched connection to the target identifier of the target switching path.

In this embodiment of this disclosure, when the target identifier of the path of the to-be-switched connection is modified, because the target identifier is modified, a path of a corresponding data flow is modified to the target switching path, so that the path of the to-be-switched connection is modified, to implement load balancing.

In a specific embodiment, the method of this application may be applied to an AI training cluster. The AI training cluster is a server cluster configured for training an artificial intelligence model (AI model). The AI training cluster uses a distributed computing technology to decompose a training task into a plurality of sub-tasks, and distributes the sub-tasks to different servers for parallel processing. The AI training cluster includes a centralized controller, a plurality of servers, and a plurality of switches. When the AI training set executes the training task, an active connection is established between the servers in the AI training cluster, and a target data packet related to the training task is transmitted. The server detects whether a congested connection (or congestion condition) exists in active connections, and sends congestion information to the centralized controller when the congested connection (or congestion condition) exists in the active connections. When the congestion information reported by the server is obtained, the centralized controller obtains a congested port and server status information of a target cluster. The server status information includes an active connection list between the servers and a corresponding candidate connection list. The centralized controller determines an active connection passing through the congested port as a to-be-switched connection, determines, as a target switching path, a path of a candidate connection in a candidate connection list corresponding to an active connection list including the to-be-switched connection, and sends the to-be-switched connection and the target switching path to a server corresponding to the to-be-switched connection. The server modifies a path of the to-be-switched connection to the target switching path. In the method of this application, centralized flow scheduling is used to eliminate network congestion, improve a network load balancing degree and bandwidth utilization, thereby increasing throughput of the AI training cluster.

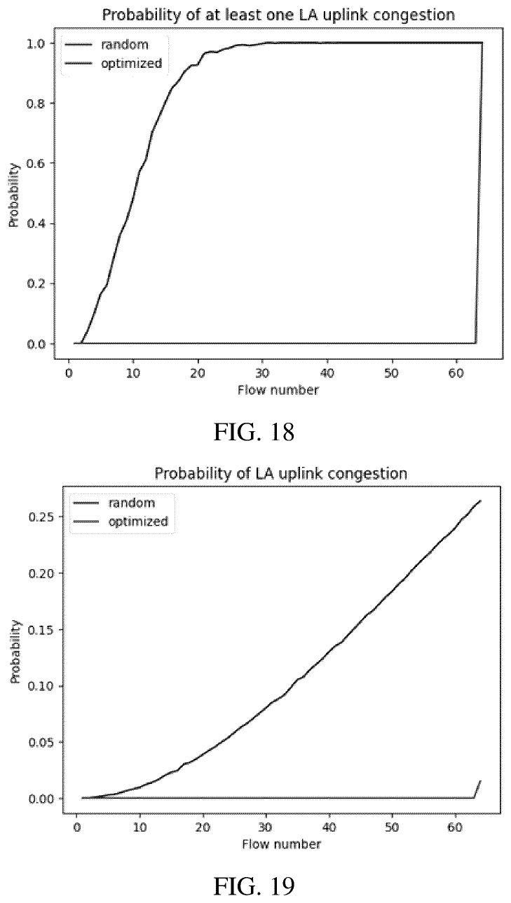

In this application, a relationship between a flow number on Leaf uplink and a congestion probability of a rack is tested through simulation by using a Monte Carlo method. Refer to FIG. 18 and FIG. 19. A horizontal coordinate represents an uplink flow number, a vertical coordinate represents a congestion probability, and a random curve and an optimized curve are two upper and lower curves respectively. The random curve is a curve that has undergone no optimized solution in this application, and the optimized curve is a curve that has undergone an optimized solution in this application. As shown in FIG. 18, when a server group uses two connections, in a typical AI training cluster network (as shown in FIG. 4), a probability of congestion occurring to Leaf uplink of a rack approaches 100% when a flow number reaches 25. In other words, when the flow number exceeds 25, congestion in at least one Leaf uplink definitely occurs. In FIG. 19, a probability of congestion in each Leaf uplink also quickly increases as a flow number increases. For example, when there are 64 flows, a congestion probability of each link reaches 25%. In practice, once a link is congested, traffic of at least two flows is damaged, and further, an AI training task to which the two flows are located is affected. Consequently, task throughput is reduced by 50%, and training duration is prolonged by 100%. An effect of this application is shown in the lower curve in the figure. To be specific, after scheduling of a centralized controller converges, both a probability that the rack is congested and a probability that each link is congested are reduced to 0, that is, congestion is completely eliminated (throughput of an AI training service is maximized). Certainly, when a new training task is initiated, congestion may occur briefly. In this case, in this application, the congestion may be detected quickly, and a path of a congested connection (or congestion condition) is switched under scheduling of a controller, to eliminate the congestion.

To better implement the cluster load balancing method provided in embodiments of this disclosure, embodiments of this disclosure further provide a cluster load balancing apparatus that is based on the foregoing cluster load balancing method. Meanings of the terms are the same as those in the foregoing cluster load balancing method. For specific implementation details, refer to the descriptions in the foregoing method embodiments.

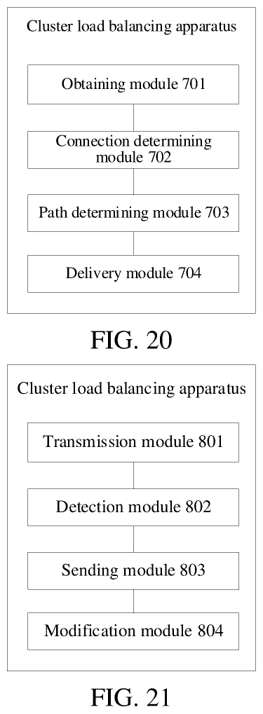

FIG. 20 is a schematic diagram of a structure of an embodiment of a cluster load balancing apparatus according to an embodiment of this disclosure. The cluster load balancing apparatus may include an obtaining module 701, a connection determining module 702, a path determining module 703, and a delivery module 704.

The obtaining module 701 is configured to obtain, when congestion information reported by a target server in a target cluster is obtained, a congested port and server status information of the target cluster, the target cluster including a plurality of servers and a plurality of switches, the switch including a plurality of switch ports, and the server status information including an active connection list between the servers and a corresponding candidate connection list.

The connection determining module 702 is configured to determine an active connection passing through the congested port as a to-be-switched connection.

The path determining module 703 is configured to determine, as a target switching path, a path of a candidate connection in a candidate connection list corresponding to an active connection list including the to-be-switched connection.

The delivery module 704 is configured to deliver the to-be-switched connection and the target switching path to a server corresponding to the to-be-switched connection, to enable the server corresponding to the to-be-switched connection to modify a path of the to-be-switched connection to the target switching path.

In an embodiment, the obtaining module is configured to:
initialize a plurality of servers and a plurality of switches based on preset network topology information, to obtain the target cluster.
classify target identifiers of data packets between server groups into different target identifier joint groups based on the target cluster, the server group including two servers, a data packet belonging to the target identifier joint group being transmitted between the server groups along a flowing path corresponding to the target identifier joint group, and the flowing path including a plurality of switch ports; and
deliver the plurality of target identifier joint groups to the servers.

In an embodiment, the target cluster includes a plurality of switch layers, and each switch layer includes a plurality of switches. The obtaining module is configured to:
respectively classify the target identifiers of the data packets between the server groups into different target identifier groups based on the switch layers; and
combine the target identifier groups at different switch layers to obtain the plurality of target identifier joint groups, a target identifier in the target identifier joint group being an intersection set of target identifiers in the target identifier groups included in the target identifier joint group.

In an embodiment, the obtaining module is configured to:
input test data packets having different tuple identifiers between the server groups to the switch layer, to obtain a switch port corresponding to each test data packet, the tuple identifier including a target identifier, and target identifiers in the tuple identifiers being different; and
place target identifiers of tuple identifiers of test data packets of the same switch port into the same target identifier group, to obtain a plurality of target identifier groups.

In an embodiment, the same hash function and hash seed are used at the same switch layer, and different hash functions and hash seeds are used at different switch layers.

In an embodiment, the target identifier is a source port number or a partial field of the source port number.

In an embodiment, the path determining module is configured to:
obtain throughput of each candidate connection in the candidate connection list; and
determine, as the target switching path, a path of a candidate connection having smallest throughput in the candidate connection list.

In an embodiment, the obtaining module is configured to:
obtain locally maintained switch status information, the switch status information including a congestion status of each switch port, and the switch status information being uploaded by each switch of the target cluster at a preset period; and
determine the congested port based on the switch status information.

For specific implementations of the foregoing modules, refer to the foregoing embodiments. Details are not described herein again.

According to the cluster load balancing apparatus, when sensing congestion based on the congestion information uploaded by the server, the centralized controller obtains a congested switch port (that is, the congested port), uses the active connection passing through the congested port as the to-be-switched connection, and selects, for switching, the path of the candidate connection from the candidate connection list corresponding to the active connection list including the to-be-switched connection. This can effectively alleviate or eliminate network congestion. The centralized controller is used to comprehensively process congestion information of each server and the congested port uploaded by the switch, and centralized flow scheduling is used to eliminate network congestion, so that a cluster load balancing degree and bandwidth utilization can be improved.

FIG. 21 is a schematic diagram of a structure of a cluster load balancing apparatus according to an embodiment of this disclosure. The cluster load balancing apparatus may include a transmission module 801, a detection module 802, a sending module 803, and a modification module 804.

The transmission module 801 is configured to establish an active connection to a server in a target cluster and transmit a target data packet.

The detection module 802 is configured to detect whether a congested connection (or congestion condition) exists in active connections.

The sending module 803 is configured to send congestion information to a centralized controller when the congested connection (or congestion condition) exists in the active connections, the centralized controller being configured to: obtain a congested port and server status information of the target cluster when receiving the congestion information; determine an active connection passing through the congested port as a to-be-switched connection; and determine, as a target switching path, a path of a candidate connection in a candidate connection list corresponding to an active connection list including the to-be-switched connection, and the server status information including an active connection list between servers and a corresponding candidate connection list.

The modification module 804 is configured to obtain the to-be-switched connection and the target switching path that are delivered by the centralized controller, and modify a path of the to-be-switched connection to the target switching path.

In an embodiment, the transmission module is configured to:
establish an active connection to another server in the target cluster when a plurality of target identifier joint groups delivered by the centralized controller are obtained, the active connection including a target identifier and a path; and
transmit, through the active connection along a path of the active connection, a target data packet having the same target identifier as that of the active connection.

In an embodiment, the modification module is configured to:
obtain a target identifier of the path of the to-be-switched connection and a target identifier of the target switching path; and
modify the target identifier of the path of the to-be-switched connection to the target identifier of the target switching path.

In an embodiment, the sending module is configured to:
perform, when the plurality of target identifier joint groups delivered by the centralized controller are obtained, path detection based on the plurality of target identifier joint groups, to obtain a candidate connection list corresponding to an active connection list of each server group, the active connection list of the server group including each active connection established between server groups, and a target identifier joint group of each candidate connection in the candidate connection list being different from a target identifier joint group of each active connection in the active connection list; and
send the active connection list and the corresponding candidate connection list to the centralized controller.

In an embodiment, the sending module is configured to:
update the active connection list and the corresponding candidate connection list at a preset period, and send an updated active connection list and corresponding candidate connection list to the centralized controller.

In an embodiment, the detection module is configured to:
detect whether a receiving end of each active connection sends back a congestion packet; and
determine, as the congested connection (or congestion condition), the active connection in which the congestion packet is sent back.

In an embodiment, the detection module is configured to:
measure a rate of each active connection; and
determine, as the congested connection (or congestion condition), the active connection having a rate lower than a preset rate.

According to the cluster load balancing apparatus, when the server finds that the congested connection (or congestion condition) exists, the server reports the congested connection (or congestion condition) to the centralized controller in a timely manner. When sensing congestion based on the congestion information uploaded by the server, the centralized controller obtains a congested switch port (that is, the congested port), uses the active connection passing through the congested port as the to-be-switched connection, and selects, for switching, the path of the candidate connection from the candidate connection list corresponding to the active connection list including the to-be-switched connection. This can effectively alleviate or eliminate network congestion. The centralized controller is used to comprehensively process congestion information of each server and the congested port uploaded by the switch, and centralized flow scheduling is used to eliminate network congestion, so that a cluster load balancing degree and bandwidth utilization can be improved.

For specific implementations of the foregoing modules, refer to the foregoing embodiments. Details are not described herein again.

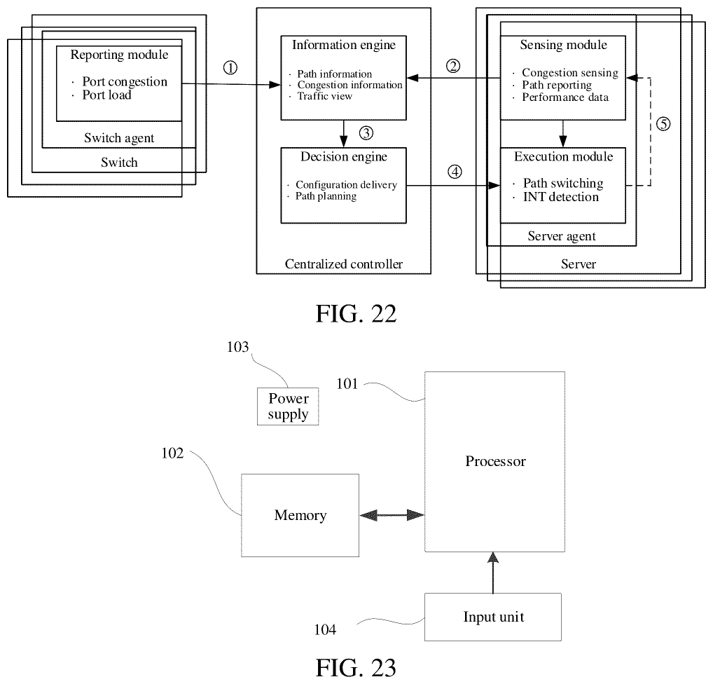

FIG. 22 is a schematic diagram of a structure of a switch, a centralized controller, and a server according to an embodiment of this disclosure.

As shown in FIG. 22, a load balancing system of this application includes a centralized controller, a server agent distributed on all servers, and a switch agent module distributed on a switch.

The centralized controller is configured to collect and comprehensively process information such as traffic information and congestion information reported by the server and the switch agent, and form a decision about traffic scheduling, to deliver the decision to the server to control a physical path of a data flow of the server. The centralized controller includes an information engine and a decision engine. The information engine is configured to construct a topology view of an entire network, superimpose a connection, traffic, and congestion information on the topology view to form a global traffic view, and comprehensively process and store various types of information into structured data that can be efficiently searched and indexed. The decision engine is configured to deliver source port number group configuration relative to path control and a path switching decision for a congested connection (or congestion condition).

The server agent is configured to detect, by using a sensing module, a path, traffic, and congestion data for detecting congestion and reporting a data flow, so that the centralized controller forms the global traffic view, executes a scheduling decision delivered by a controller, and switches a path of the data flow. An execution module may detect, by using an INT function, a physical path of a packet having a specific five-tuple in a network. A complete path form is, for example, (a sending side) Leaf->(a sending side) Spine->Core->(a receiving side) Spine->(a receiving side) Leaf. An actual INT detection result may further carry an ID of an egress port and queuing time in a queue of the egress port. The execution module may alternatively switch a network path of a connection by changing a source port number (for example, a source port number of a queue pair (QP) in RDMA over converged ethernet, version 2 (RoCEv2)/remote direct memory access (RDMA)) of the connection. In addition, the sensing module may sense a performance status of a connection by reading a congestion counter of the connection, and report these statuses to the controller.

The switch agent is configured to collect traffic and congestion information of each port, and report port congestion and port load to the centralized controller by using a reporting module, to assist the controller in seeing complete traffic and congestion distribution, so as to find an idle path that can be scheduled.

FIG. 23 is a schematic diagram of a structure of an electronic device according to an embodiment of this disclosure.

The electronic device may be a centralized controller, a server, or a switch.

The electronic device may include components such as a processor 101 of one or more processing cores, a memory 102 of one or more computer-readable storage media, a power supply 103, and an input unit 104. A person skilled in the art may understand that the structure of the electronic device shown in the figure does not constitute a limitation to the electronic device, and the electronic device may include more components or fewer components than those shown in the figure, or some components may be combined, or a different component deployment may be used.

The processor 101 is a control center of the electronic device, is connected to various parts of the entire electronic device through various interfaces and lines, and implements various functions of the electronic device and processes data by running or executing a software program and/or module stored in the memory 102 and invoking data stored in the memory 102. In an embodiment, the processor 101 may include one or more processing cores. In an embodiment, the processor 101 may integrate an application processor and a modem processor. The application processor mainly processes an operating system, a user interface, an application program, and the like. The modem processor mainly processes wireless communication. The foregoing modem processor may alternatively not be integrated in the processor 101.

The memory 102 may be configured to store a software program and module. The processor 101 runs the software program and module stored in the memory 102, to implement various functional applications and data processing. The memory 102 may mainly include a program storage region and a data storage region. The program storage region may store an operating system, an application program needed by at least one function (such as a sound playback function and an image display function), and the like. The data storage region may store data created according to use of the electronic device, and the like. In addition, the memory 102 may include a high-speed random access memory, and may further include a non-volatile memory, for example, at least one magnetic disk storage device, a flash memory, or another volatile solid-state storage device. Correspondingly, the memory 102 may further include a memory controller, to provide access of the processor 101 to the memory 102.

The electronic device further includes the power supply 103 for supplying power to the components. In an embodiment, the power supply 103 may logically connect to the processor 101 by using a power supply management system, to implement functions, such as charging, discharging, and power consumption management, by using the power supply management system. The power supply 103 may further include one or more of a direct current or alternating current power supply, a re-charging system, a power failure detection circuit, a power supply converter or inverter, a power supply state indicator, and any other elements.

The electronic device may further include the input unit 104. The input unit 104 may be configured to receive entered numeric or character information and generate keyboard, mouse, joystick, optical, or trackball signal input related to user settings and function control.

In this disclosure, a unit and a module may be hardware such as a combination of electronic circuitries; firmware; or software such as computer instructions. The unit and the module may also be any combination of hardware, firmware, and software. In some implementation, a unit may include at least one module. Each unit or module can be implemented using one or more processors (or processors and memory). Likewise, a processor (or processors and memory) can be used to implement one or more units or modules. Moreover, each unit or module can be part of an overall unit or module that includes the functionalities of the unit or module.

Although not shown, the electronic device may further include a display unit, an image acquisition element, and the like. Details are not described herein. Specifically, in this embodiment, the processor 101 in the electronic device loads, according to the following instructions, executable code (that is, computer-readable instructions) corresponding to one or more computer programs into the memory 102, and the processor 101 performs operations of the cluster load balancing method provided in this application, for example:
obtaining, when congestion information reported by a target server is obtained, a congested port and server status information of a target cluster, the server status information including an active connection list between servers and a corresponding candidate connection list; determining an active connection passing through the congested port as a to-be-switched connection; determining, as a target switching path, a path of a candidate connection in a candidate connection list corresponding to an active connection list including the to-be-switched connection; delivering the to-be-switched connection and the target switching path to a server corresponding to the to-be-switched connection; or
establishing an active connection to a server in the target cluster and transmitting a target data packet;
detecting whether a congested connection (or congestion condition) exists in active connections; and
sending the congestion information to a centralized controller when the congested connection (or congestion condition) exists in the active connections.

The electronic device provided in this embodiment of this disclosure and the cluster load balancing method in the foregoing embodiments fall within the same concept. For details about a specific implementation process, refer to the foregoing related embodiments, and are not described herein again.

This application further provides a computer-readable storage medium, having computer-readable instructions stored thereon, the stored computer-readable instructions, when executed on a processor of an electronic device provided in an embodiment of this disclosure, enabling the processor of the electronic device to perform operations in the cluster load balancing method provided in this application. The storage medium may be a magnetic disk, an optical disk, a read-only memory (ROM), a random access memory (RAM), or the like.

This application further provides a computer program product or a computer program. The computer program product or the computer program includes computer instructions stored in a computer-readable storage medium. A processor of a computer device reads the computer instructions from the computer-readable storage medium. The processor executes the computer instructions to enable the computer device to perform various implementations of the foregoing cluster load balancing method.

The cluster load balancing method and apparatus provided in this application are described above in detail. Although the principles and implementations of this application are described by using specific examples in this specification, the foregoing descriptions of embodiments are merely intended to help understand the method and core ideas of this application. Moreover, a person skilled in the art may make modifications to the specific implementations and application range according to the idea of this application. In conclusion, content of the specification is not to be construed as a limitation to this application.

When the foregoing embodiments of this disclosure are applied to a specific product or technology, relevant user data is involved, user permission or consent needs to be obtained, and collection, use, and processing of the relevant data need to comply with the laws, regulations, and standards of relevant countries and regions.

What is claimed is:

1. A method for cluster load balancing, applied to a centralized controller, comprising:
upon acquiring congestion information reported by a target server in a target cluster, obtaining a congested port and server status information of the target cluster, the target cluster comprising a plurality of servers and a plurality of switches, each switch comprising a plurality of ports, and the server status information comprising an active connection list indicating connections between the plurality of servers and a corresponding candidate connection list;
determining, from the active connection list, an active connection passing through the congested port as a to-be-switched connection;
determining, as a target switching path, a path of a candidate connection in a candidate connection list corresponding to the active connection list comprising the to-be-switched connection; and
delivering the to-be-switched connection and the target switching path to a server corresponding to the to-be-switched connection, to enable the server corresponding to the to-be-switched connection to modify a path of the to-be-switched connection to the target switching path.

2. The method according to claim 1, further comprising:
initializing the plurality of servers and the plurality of switches based on preset network topology information, to obtain the target cluster;
classifying target identifiers of data packets between server groups into a corresponding target identifier joint group in a plurality of target identifier joint groups based on the target cluster, each of the server groups comprising two servers, a data packet belonging to a target identifier joint group being transmitted between a server groups along a flowing path corresponding to the target identifier joint group, and the flowing path comprising a plurality of switch ports; and
delivering the plurality of target identifier joint groups to the plurality of servers.

3. The method according to claim 2, wherein:
the target cluster comprises a plurality of switch layers, and each switch layer comprises a plurality of switches; and
classifying the target identifiers of data packets between server groups into different target identifier joint groups based on the target cluster comprises:
respectively classifying the target identifiers of the data packets between the server groups into different target identifier groups based on the switch layers; and
combining the target identifier groups at different switch layers to obtain the plurality of target identifier joint groups, a target identifier in the target identifier joint group being an intersection set of target identifiers in the target identifier groups comprised in the target identifier joint group.

4. The method according to claim 3, wherein respectively classifying the target identifiers of the data packets between the server groups into different target identifier groups based on the switch layers comprises:
inputting, to the switch layer, test data packets having different tuple identifiers exchanged between the server groups, to obtain a switch port corresponding to each test data packet, the tuple identifier comprising a target identifier, and target identifiers in the different tuple identifiers being mutually distinct; and
placing target identifiers of tuple identifiers of test data packets corresponding to a same switch port into a same target identifier group, to obtain a plurality of target identifier groups.

5. The method according to claim 3, wherein a same hash function and a same hash seed are used at the same switch layer, across switch layers, hash functions are mutually different and hash seeds are mutually different.

6. The method according to claim 2, wherein the target identifier comprises at least one of: a source port number or a partial field of the source port number.

7. The method according to claim 1, wherein determining, as the target switching path, the path of a candidate connection in the candidate connection list corresponding to the active connection list comprising the to-be-switched connection comprises:
obtaining throughput of each candidate connection in the candidate connection list; and
determining, as the target switching path, a path of a candidate connection having a smallest throughput in the candidate connection list.

8. The cluster load balancing method according to claim 1, wherein obtaining the congested port and the server status information of the target cluster comprises:
obtaining locally maintained switch status information, the switch status information comprising a congestion status of each switch port, and the switch status information being uploaded by each switch of the target cluster at a preset period; and
determining the congested port based on the switch status information.

9. A method for cluster load balancing, applied to a server in a target cluster, the target cluster comprising a centralized controller, a plurality of servers, and a plurality of switches, the switch comprising a plurality of switch ports, and the method comprising:
establishing an active connection to a server in the plurality of servers and transmitting a target data packet;
detecting whether a congestion condition exists in the active connection;
sending congestion information to the centralized controller when the congestion condition exists in the active connection, the centralized controller being configured to: obtain a congested port in the active connection and server status information of the target cluster when receiving the congestion information; determine the active connection passing through the congested port as a to-be-switched connection; and determine, as a target switching path, a path of a candidate connection in a candidate connection list corresponding to an active connection list comprising the to-be-switched connection, and the server status information comprising an active connection list between the servers and a corresponding candidate connection list; and
obtaining, from the centralized controller, the to-be-switched connection and the target switching path, and modifying a path of the to-be-switched connection to the target switching path.

10. The method according to claim 9, wherein establishing the active connection to the server in the target cluster and transmitting the target data packet comprises:
upon a plurality of target identifier joint groups delivered by the centralized controller being obtained, establishing the active connection connecting to another server in the target cluster, the active connection comprising a target identifier and a path; and
transmitting, via the active connection along the path of the active connection, the target data packet having a same target identifier as that of the active connection.

11. The method according to claim 9, wherein modifying the path of the to-be-switched connection to the target switching path comprises:
obtaining a target identifier of the path of the to-be-switched connection and a target identifier of the target switching path; and
modifying the target identifier of the path of the to-be-switched connection to the target identifier of the target switching path.

12. The method according to claim 9, further comprising:
upon obtaining the plurality of target identifier joint groups delivered by the centralized controller, performing path detection based on the plurality of target identifier joint groups, to obtain a candidate connection list corresponding to an active connection list of each server group, the active connection list of the server group comprising each active connection established between server groups, and a target identifier joint group of each candidate connection in the candidate connection list being different from a target identifier joint group of each active connection in the active connection list; and
sending the active connection list and the corresponding candidate connection list to the centralized controller.

13. The method according to claim 12, further comprising:
updating the active connection list and the corresponding candidate connection list at a preset period, and
sending an updated active connection list and corresponding candidate connection list to the centralized controller.

14. The method according to claim 9, wherein detecting whether the congestion condition exists in the active connection comprises:
detecting whether a receiving end of the active connection sends back a congestion packet indicating the congestion condition; and
determining, congested connection, that the congestion condition exists in the active connection.

15. The method according to claim 9, wherein the detecting whether the congestion condition exists in the active connection comprises:
measuring a rate of the active connection; and
determining that the congestion condition exists in the active connection if the rate of the active connection is lower than a preset rate.

16. A device comprising a memory for storing computer instructions and a processor in communication with the memory, wherein, when the processor executes the computer instructions, the processor is configured to cause the device to:
upon acquiring congestion information reported by a target server in a target cluster, obtain a congested port and server status information of the target cluster, the target cluster comprising a plurality of servers and a plurality of switches, each switch comprising a plurality of ports, and the server status information comprising an active connection list indicating connections between the plurality of servers and a corresponding candidate connection list;
determine, from the active connection list, an active connection passing through the congested port as a to-be-switched connection;
determine, as a target switching path, a path of a candidate connection in a candidate connection list corresponding to the active connection list comprising the to-be-switched connection; and
deliver the to-be-switched connection and the target switching path to a server corresponding to the to-be-switched connection, to enable the server corresponding to the to-be-switched connection to modify a path of the to-be-switched connection to the target switching path.

17. The device according to claim 16, wherein, when the processor executes the computer instructions, the processor is configured to further cause the device to:
initialize the plurality of servers and the plurality of switches based on preset network topology information, to obtain the target cluster;
classify target identifiers of data packets between server groups into a corresponding target identifier joint group in a plurality of target identifier joint groups based on the target cluster, each of the server groups comprising two servers, a data packet belonging to a target identifier joint group being transmitted between a server group along a flowing path corresponding to the target identifier joint group, and the flowing path comprising a plurality of switch ports; and
deliver the plurality of target identifier joint groups to the plurality of servers.

18. The device according to claim 17, wherein:
the target cluster comprises a plurality of switch layers, and each switch layer comprises a plurality of switches; and
when the processor is configured to cause the device to classify the target identifiers of data packets between server groups into different target identifier joint groups based on the target cluster, the processor is configured to cause the device to:
respectively classify the target identifiers of the data packets between the server groups into different target identifier groups based on the switch layers; and
combine the target identifier groups at different switch layers to obtain the plurality of target identifier joint groups, a target identifier in the target identifier joint group being an intersection set of target identifiers in the target identifier groups comprised in the target identifier joint group.

19. The device according to claim 18, wherein, when the processor is configured to cause the device to respectively classify the target identifiers of the data packets between the server groups into different target identifier groups based on the switch layers, the processor is configured to cause the device to:
input, to the switch layer, test data packets having different tuple identifiers exchanged between the server groups, to obtain a switch port corresponding to each test data packet, the tuple identifier comprising a target identifier, and target identifiers in the different tuple identifiers being mutually distinct; and
place target identifiers of tuple identifiers of test data packets corresponding to a same switch port into a same target identifier group, to obtain a plurality of target identifier groups.

20. The device according to claim 18, wherein a same hash function and a same hash seed are used at the same switch layer, across switch layers, hash functions are mutually different and hash seeds are mutually different.
